(19) United States
(12) Patent Application Publication
(10) Pub. No.: US 2005/0044708 A1
(43) Pub. Date: Mar. 3, 2005

(54) METHOD FOR MANUFACTURING A HOLLOW BLADE FOR A STATOR OR ROTOR COMPONENT

(75) Inventors: Jan LUNDGREN, Grundsund (SE); Joakim Carlsson, Vanersborg (SE); Peter Jonsson, Hjartum (SE); Borje Nordin, Trollhattan (SE)

Correspondence Address: TRACY W. DRUCE, ESQ.;NOVAK DRUCE & QUIGG LLP, 1615 L STREET NW, SUITE 850, WASHINGTON, DC, 20036, US

(73) Assignee: VOLVO AERO CORPORATION, Trollhattan (SE)

(21) Appl. No.: 10/708,385

(22) Filed: Feb. 27, 2004

Related U.S. Application Data
(63) Continuation of application No. PCT/SE02/01457, filed on Aug. 14, 2002.

(30) Foreign Application Priority Data
Aug. 29, 2001 (SE) 0102882-8

(51) Int. Cl. B26B 21/00; B23P 15/04

(52) U.S. Cl. 29/889.72; 29/889.23; 29/889.7

(57) ABSTRACT

Method for manufacturing a hollow blade configured to function as a stator or rotor component and having at least one support element positioned between two opposite blade walls, and joined together by welding. The support element is joined together with at least one of the blade walls by means of laser-welding from the outside of the blade in such a way that the joined-together portions of the support element and the blade wall form a T-shaped joint.

### CROSS REFERENCE TO RELATED APPLICATIONS

The present application is a continuation patent application of International Application No. PCT/SE02/01457 filed 14 Aug. 2002 which was published in English pursuant to Article 21(2) of the Patent Cooperation Treaty, and which claims priority to Swedish Application No. 0102882-8 filed 29 Aug. 2001. Both applications are expressly incorporated herein by reference in their entireties.

### BACKGROUND OF INVENTION

1. Field of the Invention

The present invention relates to a method for manufacturing a hollow blade intended for a stator component or rotor component and having at least one support element positioned between two opposite blade walls, and joined together therewith. The stator or rotor component can be used, for example, in a gas turbine, and in particular in a jet engine.

The term jet engine includes various types of engines which take in air at relatively low speed, heat it by combustion, and discharge it at much higher speed. For example, the term jet engine includes turbo-jet engines and turbo-fan engines.

The blades can therefore be used for both static and rotary parts. In the former case, the blade can be used as what is known as a strut. Such struts are arranged between an outer ring and an inner ring in the stator. In stators, the struts are chiefly intended to be force-transmitting and usually have such a shape that they offer as little air resistance as possible. The struts can, for example, be arranged in a rear or front support in a jet engine. In rotors, the blades can be used as fan blades for the purpose of deflecting a flow, for example in a jet engine.

The blades are of hollow design for the purpose of optimizing their weight. The support elements are arranged between the blade walls in order to reinforce the blades and are therefore often referred to as reinforcing ribs.

2. Background Art

It is known to join together support element(s) and blade walls by means of resistance welding. In this case, the support element is elongate with a U-shaped cross section and is positioned so that each of the two legs of the U extends parallel to, and in contact with a blade wall. The intermediate part of the U then forms a spacing element between the blade walls. Owing to the necessity of pressing together the surfaces to be welded together, a stay is positioned between the legs of the U before welding, after which each of the legs of the U is resistance-welded firmly to the blade from the outside of the blade wall. The stay is then removed from the blade. One disadvantage of this method is that it is relatively time-consuming to place the stay in the intended position and to remove it after welding has been carried out. It is also difficult to achieve sufficiently good quality. In structural terms, it is not an optimum solution, because stress concentrations tend to occur, resulting in that the weld is not sufficiently strong.

Other known welding methods for firmly welding a support element between blade walls consist of electron beam welding and TIG welding. Both of these welding techniques have proved to be associated with problems in the form of crack formation after being used for a time.

Electron beam welding is also a relatively complicated and expensive method. At the edges, it is difficult to achieve complete fusion with fine transitions.

Another variant is what is known as diffusion bonding including superplastic forming. In this variant, use is in principle made of three plates which, in certain mutually separate areas, are interconnected. The connection is made by virtue of the plates being caused, in these areas, to diffuse into one another at high temperature and high pressure. After this first processing phase, the construction is subjected to high internal pressure so that the desired geometry is obtained.

### SUMMARY OF INVENTION

One object of the present invention is to provide a method for connecting a support element to a blade wall that results in a joint of higher strength than presently employed methods, and/or are more cost-effective to manufacture.

This object is achieved at least in part by virtue of the fact that the support element is joined together with at least one of the blade walls by means of laser-welding from the outside of the blade in such a way that the joined portions of the support element and the blade wall form a T-shaped joint. Suitable selection of material parameters and welding parameters makes it possible to obtain a T-shaped joint with rounded corners, or at least a smooth transition between welded-together parts, inside the blade. This results in a high-strength construction and thus an extended life. Alternatively, a construction with thinner wall thicknesses, and thus reduced weight can be obtained.

According to a preferred embodiment of the invention, the support element is arranged so that it extends essentially at right angles to the mean camber line of the blade. Mean camber line means a line which extends halfway between the outer surface of an upper blade wall and the outer surface of a lower blade wall. Such an arrangement of the support element results in a construction of still higher strength.

According to another preferred embodiment of the invention, the support element has the shape of a plate. Plate shape means that the support element has two parallel side surfaces at a relatively short distance from one another. This is a simple shape in manufacturing terms, and thus a cost-effective construction element.

According to one variation on the preceding embodiment, the edge of the plate-shaped support element is connected to the blade wall. In this context, “edge” is utilized to mean the elongate surface which connects the two side surfaces of the plate.

Further preferred embodiments and advantages of the invention emerge from the claims and the description below.

### BRIEF DESCRIPTION OF DRAWINGS

The invention will be described in greater detail below with reference to exemplary embodiments which are shown in the accompanying drawings, and in which:

FIG. 1 is a perspective view of a blade manufactured according to the present invention; and

FIG. 2 is a cross-sectional view of a welded joint.

### DETAILED DESCRIPTION

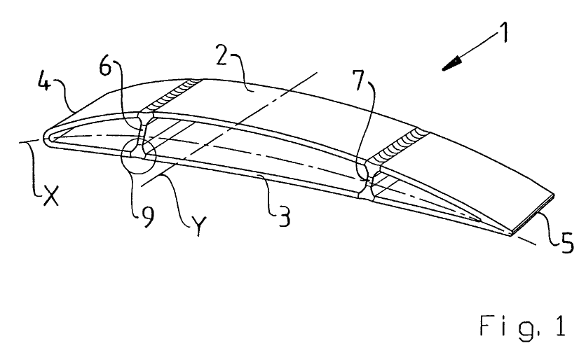

FIG. 1 shows a hollow blade 1 in a perspective view. The blade 1 has a first side wall 2 and a second side wall 3 located opposite one another. The first side wall 2 has a convex cross-sectional shape, and the second side wall 3 has a concave cross-sectional shape. A mean camber line, X, is indicated by a dot-dash line. The mean camber line extends centrally in the blade from a front end 4 of the blade to a rear end 5 of the blade. The front end and rear end are described in relation to the direction from which the gas flow is intended to act during use of the blade in a stator or rotor component.

Furthermore, two plate-shaped support elements 6, 7 are arranged inside the blade 1. The plate-shaped support elements 6, 7 are arranged upright inside the blade 1 and extend essentially at right angles to the mean camber line, X. Each of the plate-shaped support elements 6, 7 is elongate and extends in the transverse direction of the blade 1, indicated here by a broken line, Y.

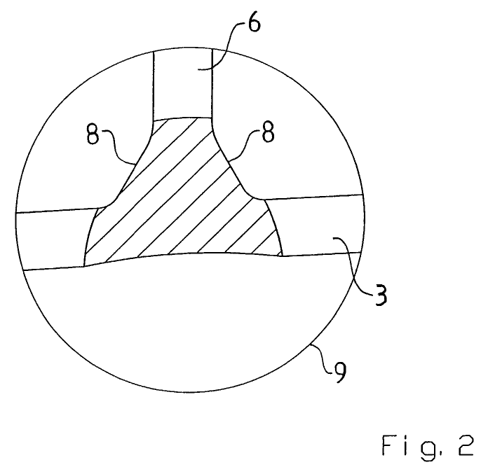

The hollow blade 1 is manufactured in a conventional manner. The plate-shaped support elements 6, 7 are subsequently placed in their intended positions inside the blade, and then each of the support elements 6, 7 is laser-welded firmly to the walls 2, 3 from the outside of the blade. The laser-welding is carried out in such a way that the joined-together portions of the support element 6, 7 and the blade wall 2, 3 form a T-shaped joint 9 (see also FIG. 2). In other words, the support element 6, 7 is concealed by the wall 2, 3 of the blade as seen from the outside of the blade wall during welding.

More specifically, T-joint 9 means that a portion of the blade wall 3 forms the crosspiece part of the T, and a portion of the support element 6 forms the upright part of the T which joins the crosspiece part.

The materials used for the blade walls 2, 3 and the support elements 6, 7 consist of weldable materials, such as stainless steel, for example of the type 347 or A286. Use can alternatively be made of nickel-based alloys such as, for example, INCO600, INCO625, INCO718 and Hastaloy x. According to other variants, cobalt-based alloys, for example of the type HAYNES 188 and HAYNES 230, can be used. Titanium alloys, such as Ti6-4, and various types of aluminum alloys, can also be used. Combinations of different materials are also possible.

For the laser-welding, use is preferably made of an Nd:YAG-laser, but other types of welding arrangement, for example CO₂-lasers, can also be used in accordance with the invention.

By accurately matching the welding procedure, material selection and dimensions of blade walls and support elements, the laser-welding produces the T-shape at the joint and also a softly rounded shape 8 on the inner corners between the support plate 6, 7 and the blade walls 2, 3. The thickness of the blade wall and the support element is preferably in the range 0.5-5.0 mm, and in particular, in the range of 1-2 mm. Welding is suitably effected by means of a continuous weld. The rounded shape 8 of the welded joints results in a high-strength construction and thus a long life of the component.

According to an illustrative embodiment, use was made of the following parameters:
Wall thickness: 1.23 mm
Material: Ti6-4
Power: 1.3 kW
Welding speed: 1000 mm/min
Protective gas and root gas: argon.

As an alternative or complement, use can be made of helium and/or oxygen, and mixtures thereof, as protective gas and root gas.

In order that the welded joint comes to lie in exactly the correct position, a previously known joint-tracking technique can be used.

The invention is not to be regarded as being limited to the illustrative embodiment described above, but a number of further variants and modifications are conceivable within the scope of the patent claims.

The invention is, however, not limited to blades of the curving airfoil type, but can also be used for blades of the symmetrical airfoil type. In such a case, the mean camber line X mentioned above coincides with the symmetry line of the blade. The symmetry line of the blade coincides with the longitudinal direction of the blade; that is to say, a straight line from its front edge to its rear edge in the intended gas-flow direction.

The invention is not to be regarded as being limited to manufacturing a blade for a gas turbine, but the method can be used for manufacturing blades for other applications, such as an aircraft wing. In such a case, the stator component forms the aircraft wing.

According to the description above, the support element has the shape of a plate which is continuous in the transverse direction of the blade. Alternatively, it would be possible to envisage a number of support elements in the form of struts or a framework forming the reinforcement between the two side walls.

1. A method for manufacturing a hollow blade for utilization in a stator component or rotor component, said method comprising:
positioning at least one support element between two opposite blade walls of a hollow blade and joining the support element together with at least one of the two opposite blade walls utilizing laser-welding from the outside of the blade to be joined to the support element so that the joined-together portions of the support element and the joined blade wall form a substantially T-shaped joint.

2. The method as recited in claim 1, wherein said support element is arranged to extend essentially at right angles to a mean camber line of the blade.

3. The method as recited in claim 1, wherein said support element is plate-shaped.

4. The method as recited in claim 3, wherein the edge of the plate-shaped support element is connected to the blade wall.

5. The method as recited in claim 1, wherein during manufacture of the hollow blade, the support element is first positioned inside the blade and then welded firmly to the wall.

6. The method as recited in claim 1, wherein in cross-section, an outer contour of the blade forms the shape of an airfoil.

7. The method as recited in claim 1, wherein the stator or rotor component is configured for incorporation into a gas turbine.

8. The method as recited in claim 1, wherein the stator or rotor component is configured for incorporation into a jet engine.

9. The method as recited in claim 1, wherein the stator or rotor component is configured to form at least part of an aircraft wing.
